(19) United States
(12) Patent Application Publication
(10) Pub. No.: US 2026/0219612 A1
(43) Pub. Date: Jul. 30, 2026

(54) FIXING DEVICE AND IMAGE FORMING APPARATUS

(71) Applicant: FUJIFILM Business Innovation Corp., Tokyo (JP)

(72) Inventors: Kenji OMORI, Kanagawa (JP); Yasutaka GOTOH, Kanagawa (JP); Masayuki SEKO, Kanagawa (JP); Yasuhiko KINUTA, Kanagawa (JP); Hitoshi KOMURO, Kanagawa (JP); Hideaki OHARA, Kanagawa (JP); Toshiyuki MIYATA, Kanagawa (JP)

(73) Assignee: FUJIFILM Business Innovation Corp., Tokyo (JP)

(21) Appl. No.: 19/426,100

(22) Filed: Dec. 19, 2025

(30) Foreign Application Priority Data
Jan. 24, 2025 (JP) 2025-010971

(51) Int. Cl. G03G 15/20

(52) U.S. Cl. CPC G03G 15/2057; G03G 15/2064; G03G 2215/2035

(57) ABSTRACT

A fixing device includes a fixing belt member including a base material and a surface layer that is disposed on the base material and is a cured product of a composition containing a siloxane compound represented by Formula 1, a heating member that is disposed on an inner surface side of the fixing belt member, and a pressurizing roll member that is disposed to be in contact with an outer surface of the fixing belt member.

$${( {{R}_{3}^{1} SiO}_{1 / 2} )}_{a} {( {R}_{2}^{1} {SiO}_{2 / 2} )}_{b} {( {R}^{1} {SiO}_{3 / 2} )}_{c} {( {SiO}_{4 / 2} )}_{d} {( {R}^{2} {O}_{1 / 2} )}_{e} \qquad Formula 1$$

(in Formula 1, R¹'s each independently represent a hydrogen atom, an alkyl group, an alkenyl group, an alkynyl group, an aralkyl group, an aryl group, a group represented by —C(═O)—CR³₃, or a monovalent organic group having a reactive group, provided that a plurality of R¹'s may be the same or different from each other, R² represents a hydrogen atom or an alkyl group, provided that a plurality of R²'s may be the same or different from each other, R³ represents a hydrogen atom, a methyl group, or an ethyl group, provided that a plurality of R³'s may be the same or different from each other, the monovalent organic group may be substituted with a halogen atom, a hydroxy group, an alkoxy group, an aryloxy group, an aralkyloxy group, or an oxy group, and the alkyl group, the alkenyl group, the alkynyl group, the aralkyl group, and the aryl group may have a substituent, and a, b, d, and e each independently represent 0 or more and 1 or less, c represents more than 0 and 1 or less, and a+b+c+d+e=1)

### CROSS-REFERENCE TO RELATED APPLICATIONS

This application is based on and claims priority under 35 USC 119 from Japanese Patent Application No. 2025-010971 filed Jan. 24, 2025.

### BACKGROUND

### (i) Technical Field

The present disclosure relates to a fixing device and an image forming apparatus.

### (ii) Description of Related Art

In an electrophotographic image forming apparatus, an image is formed by bringing a fixing member into contact with a toner image transferred onto a recording medium and heating and pressurizing the toner image to fix the toner image on the recording medium.

For example, JP2617858B discloses a fixing device for fixing an unfixed toner image carried on a recording material to the recording material by heating and pressurizing the unfixed toner image, the fixing device including a fixing unit that includes a pair of rollers consisting of a fixing roller and a pressure roller that are in contact with each other and are rotatable, each have at least one heating unit in an inside thereof, and are used for sandwiching and heating and pressurizing the recording material carrying the unfixed toner image, in which the fixing roller has a core member and an elastic layer formed of an addition type silicone rubber elastic material on a surface side of the core member, and the addition type silicone rubber elastic material is a cured product of a polysiloxane mixture containing at least (a) a vinyl group-terminated linear dimethylpolysiloxane having a viscosity at 25° C. of 80,000 poise or less, and (b) a resinous organopolysiloxane having a viscosity at 25° C. of 10 poise or more, that contains a block copolymer having two or more vinyl groups and having, within the same molecule, a resin segment containing at least one of tetrafunctional or trifunctional siloxane units and a linear oil segment having at least 100 consecutive difunctional structural units.

### SUMMARY

Aspects of non-limiting embodiments of the present disclosure relate to a fixing device and an image forming apparatus, in which image defects in a fixed image are suppressed, as compared with a fixing device including a fixing belt member not including a surface layer that is a cured product of a composition containing a siloxane compound represented by Formula 1.

Aspects of non-limiting embodiments of the present disclosure relate to a fixing device and an image forming apparatus, in which image defects in a fixed image are suppressed while maintaining release properties with respect to a toner image, as compared with a fixing device including a surface layer having a surface energy of more than 40 mJ/m² at 25° C. or a surface layer having a linear thermal expansion coefficient of more than 130 ppm/° C. at 150° C.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present disclosure, there is provided a fixing device including:
a fixing belt member including a base material and a surface layer that is disposed on the base material and is a cured product of a composition containing a siloxane compound represented by Formula 1;
a heating member that is disposed on an inner surface side of the fixing belt member; and
a pressurizing roll member that is disposed to be in contact with an outer surface of the fixing belt member,

$${( {{R}_{3}^{1} SiO}_{1 / 2} )}_{a} {( {R}_{2}^{1} {SiO}_{2 / 2} )}_{b} {( {R}^{1} {SiO}_{3 / 2} )}_{c} {( {SiO}_{4 / 2} )}_{d} {( {R}^{2} {O}_{1 / 2} )}_{e} , \qquad Formula 1$$

(in Formula 1,
R¹'s each independently represent a hydrogen atom, an alkyl group, an alkenyl group, an alkynyl group, an aralkyl group, an aryl group, a group represented by —C(═O)—CR³₃, or a monovalent organic group having a reactive group, provided that a plurality of R¹'s may be the same or different from each other,
R² represents a hydrogen atom or an alkyl group, provided that a plurality of R²'s may be the same or different from each other,
R³ represents a hydrogen atom, a methyl group, or an ethyl group, provided that a plurality of R³'s may be the same or different from each other,
the monovalent organic group may be substituted with a halogen atom, a hydroxy group, an alkoxy group, an aryloxy group, an aralkyloxy group, or an oxy group, and the alkyl group, the alkenyl group, the alkynyl group, the aralkyl group, and the aryl group may have a substituent, and
a, b, d, and e each independently represent 0 or more and 1 or less, c represents more than 0 and 1 or less, and a+b+c+d+e=1).

### BRIEF DESCRIPTION OF THE DRAWINGS

Exemplary embodiment(s) of the present invention will be described in detail based on the following figures, wherein:

FIG. 1 is a schematic cross-sectional view showing an example of a fixing belt member used in a fixing device according to the present exemplary embodiment;

FIG. 2 is a view schematically showing a configuration of an example of an exemplary embodiment of a fixing device according to the present exemplary embodiment;

FIG. 3 is a view schematically showing a configuration of an example of an image forming apparatus according to the present exemplary embodiment; and

FIG. 4 is a flowchart showing an example of a flow of driving of the fixing device in the image forming apparatus according to the present exemplary embodiment, in a case where a print start instruction is received.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. In addition, in the present disclosure, the upper limit value or lower limit value of a numerical range may be replaced with values described in examples.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In the present disclosure, in a case where the amount of each component in a composition is mentioned, and there are two or more kinds of substances corresponding to each component in the composition, unless otherwise specified, the amount of each component means the total amount of two or more kinds of the substances present in the composition.

### Fixing Device

### Fixing Device According to First Exemplary Embodiment

A fixing device according to a first exemplary embodiment of the present disclosure includes a fixing belt member including a base material and a surface layer that is disposed on the base material and is a cured product of a composition containing a siloxane compound represented by Formula 1, a heating member that is disposed on an inner surface side of the fixing belt member, and a pressurizing roll member that is disposed to be in contact with an outer surface of the fixing belt member.

$${( {{R}_{3}^{1} SiO}_{1 / 2} )}_{a} {( {R}_{2}^{1} {SiO}_{2 / 2} )}_{b} {( {R}^{1} {SiO}_{3 / 2} )}_{c} {( {SiO}_{4 / 2} )}_{d} {( {R}^{2} {O}_{1 / 2} )}_{e} \qquad Formula 1$$

(in Formula 1, R¹'s each independently represent a hydrogen atom, an alkyl group, an alkenyl group, an alkynyl group, an aralkyl group, an aryl group, a group represented by —C(═O)—CR³₃, or a monovalent organic group having a reactive group,
provided that at least one of a plurality of R¹'s is a monovalent organic group having a reactive group, and a plurality of R¹'s may be the same or different from each other,
R² represents a hydrogen atom or an alkyl group, provided that a plurality of R²'s may be the same or different from each other,
R³ represents a hydrogen atom, a methyl group, or an ethyl group, provided that a plurality of R³'s may be the same or different from each other,
the monovalent organic group may be substituted with a halogen atom, a hydroxy group, an alkoxy group, an aryloxy group, an aralkyloxy group, or an oxy group, and the alkyl group, the alkenyl group, the alkynyl group, the aralkyl group, and the aryl group may have a substituent, and
a, b, d, and e each independently represent 0 or more and 1 or less, c represents more than 0 and 1 or less, and a+b+c+d+e=1)

### Fixing Device According to Second Exemplary Embodiment

A fixing device according to a second exemplary embodiment of the present disclosure includes a fixing belt member including a base material and a surface layer that is disposed on the base material, has a surface energy of 40 mJ/m² or less at 25° C., and has a linear thermal expansion coefficient of 130 ppm/° C. or less at 150° C., a heating member that is disposed on an inner surface side of the fixing belt member, and a pressurizing roll member that is disposed to be in contact with an outer surface of the fixing belt member.

In the image forming apparatus, a fixing device that fixes a toner image onto a recording medium by bringing a fixing belt member into contact with the toner image on the recording medium and heating and pressurizing the toner image is used. The fixing belt member is required to have release properties with respect to the toner image. Therefore, the fixing belt member has a laminated structure, and a surface layer directly in contact with the toner image contains a component that increases the release properties, such as a fluororesin (for example, tetrafluoroethylene-perfluoroalkyl vinyl ether (PFA)). However, in the fixing belt member in which the fluororesin is contained in the surface layer, a difference in thermal expansion coefficient occurs at a boundary portion between a region (so-called paper-passing region) in contact with the recording medium and a region (so-called non-paper-passing region) not in contact with the recording medium. The difference in thermal expansion coefficient may cause wrinkling deformation (that is, deformation of permanent strain) at the boundary portion of the fixing belt member. In a case where the wrinkling deformation occurs at the boundary portion of the fixing belt member, image defects such as gloss unevenness and defects caused by the wrinkling deformation may occur in the fixed image.

On the other hand, in the fixing device according to the first exemplary embodiment, the surface layer of the fixing belt member is a cured product of a composition containing a siloxane compound represented by Formula 1. By the surface layer being the cured product of the siloxane compound represented by Formula 1, release properties of the surface layer are increased. In addition, the cured product of the siloxane compound represented by Formula 1 is less likely to have a large difference in thermal expansion coefficient between the paper-passing portion and the non-paper-passing portion, as compared with the fluororesin. Therefore, the wrinkling deformation at the boundary portion of the fixing belt member is suppressed. As a result, the occurrence of image defects caused by the wrinkling deformation of the fixing belt member is suppressed in the fixed image.

In addition, in the fixing device according to the second exemplary embodiment, the surface energy of the surface layer of the fixing belt member is 40 mJ/m² or less at 25° C., and the linear thermal expansion coefficient is 130 ppm/° C. or less at 150° C. By the surface energy being in the above-described range, the release properties of the surface layer are increased, and the release properties with respect to the toner image are maintained. In addition, by the linear thermal expansion coefficient being in the above-described range, the difference in thermal expansion coefficient between the paper-passing portion and the non-paper-passing portion is less likely to be large. Therefore, the wrinkling deformation at the boundary portion of the fixing belt member is suppressed. As a result, the occurrence of image defects caused by the wrinkling deformation of the fixing belt member is suppressed in the fixed image.

As described above, it is presumed that, with the fixing device according to the first and second exemplary embodiments of the present disclosure, the image defects in the fixed image are suppressed.

Hereinafter, the first and second exemplary embodiments of the present disclosure will be described in detail.

### Fixing Belt Member

### Surface Layer

The surface layer of the fixing belt member in the fixing device according to the first exemplary embodiment of the present disclosure (hereinafter, also simply referred to as “surface layer according to first exemplary embodiment”) is a cured product of a composition containing a siloxane compound represented by Formula 1.

The surface layer of the fixing belt member in the fixing device according to the second exemplary embodiment of the present disclosure (hereinafter, also simply referred to as “surface layer according to second exemplary embodiment”) has a surface energy of 40 mJ/m² or less at 25° C. and a linear thermal expansion coefficient of 130 ppm/° C. or less at 150° C. For example, the surface layer according to the second exemplary embodiment preferably contains a silsesquioxane derivative as a method for controlling the surface energy and the linear thermal expansion coefficient in the above-described ranges, and preferably a cured product of a composition containing a siloxane compound represented by Formula 1.

For example, it is preferable that a content of a fluororesin (that is, a resin including a fluorine atom in a molecular structure) is low in both the surface layer according to the first exemplary embodiment and the surface layer according to the second exemplary embodiment. Specifically, for example, the content of the fluororesin with respect to the surface layer is preferably 1% by mass or less, and more preferably 0.1% by mass or less. Furthermore, for example, it is preferable that the surface layer does not contain the fluororesin.

### Siloxane Compound

The siloxane compound represented by Formula 1 is a polymer compound called a silsesquioxane, in which a main chain skeleton consists of Si—O bonds and various skeleton structures are taken. The siloxane compound SQ may have, as a skeleton structure, any of a cage-type structure (a perfect cage-type structure or a cage-type structure), a ladder-type structure, or a random structure. The siloxane compound represented by Formula 1 may be only one kind or two or more kinds.

$${( {{R}_{3}^{1} SiO}_{1 / 2} )}_{a} {( {R}_{2}^{1} {SiO}_{2 / 2} )}_{b} {( {R}^{1} {SiO}_{3 / 2} )}_{c} {( {SiO}_{4 / 2} )}_{d} {( {R}^{2} {O}_{1 / 2} )}_{e} \qquad Formula 1$$

In Formula 1, R¹'s each independently represent a hydrogen atom, an alkyl group, an alkenyl group, an alkynyl group, an aralkyl group, an aryl group, a group represented by —C(═O)—CR³₃, or a monovalent organic group having a reactive group.

A plurality of R¹'s may be the same or different from each other.

R² represents a hydrogen atom or an alkyl group. A plurality of R²'s may be the same or different from each other.

R³ represents a hydrogen atom, a methyl group, or an ethyl group. A plurality of R³'s may be the same or different from each other.

The monovalent organic group may be substituted with a halogen atom, a hydroxy group, an alkoxy group, an aryloxy group, an aralkyloxy group, or an oxy group. The alkyl group, the alkenyl group, the alkynyl group, the aralkyl group, and the aryl group may have a substituent.

a, b, d, and e each independently represent 0 or more and 1 or less, c represents more than 0 and 1 or less, and a+b+c+d+e=1. a, b, c, d, and e represent an average value of a proportion of the number of moles of each constitutional unit contained in one molecule of the siloxane compound.

The siloxane compound represented by Formula 1 has five constitutional units of “R¹₃SiO_{1/2}” (hereinafter, referred to as “constitutional unit 1”), “R¹₂SiO_{2/2}” (hereinafter, referred to as “constitutional unit 2”), “R¹SiO_{3/2}” (hereinafter, referred to as “constitutional unit 3”), “SiO_{4/2}” (hereinafter, referred to as “constitutional unit 4”), and “R¹O_{1/2}” (hereinafter, referred to as “constitutional unit 5”).

Each of the constitutional unit 1 to the constitutional unit 5 in Formula 1 may be only one kind or two or more kinds. In addition, an arrangement order of the constitutional units is not limited to the arrangement order represented by Formula 1, and is not particularly limited.

The siloxane compound represented by Formula 1 includes at least the constitutional unit 3 (that is, the constitutional unit represented by “R¹SiO_{3/2}”). That is, in Formula 1, c is a positive number of more than 0 and 1 or less.

For example, the siloxane compound represented by Formula 1 preferably includes the constitutional unit 2 together with the constitutional unit 3. That is, in Formula 1, for example, it is preferable that b and c are each independently a positive number of more than 0 and 1 or less, and a, d, and e are 0 or a positive number in a range of a+b+c+d+e=1.

The siloxane compound represented by Formula 1 may be composed of only the constitutional unit 3 (that is, c may be 1, and all of a, b, d, and e may be 0).

### Constitutional Unit 1

The group represented by R¹ in the constitutional unit 1 (that is, the constitutional unit represented by “R¹₃SiO_{1/2}”) is at least one selected from the group consisting of a hydrogen atom, an alkyl group, an alkenyl group, an alkynyl group, an aralkyl group, an aryl group, —C(═O)—CR³₃, and a monovalent organic group having a reactive group (hereinafter, also referred to as a “polymerizable functional group”). R¹ of the present constitutional unit is, for example, preferably at least one selected from the group consisting of a hydrogen atom, a polymerizable functional group, an aryl group, and an alkyl group; and more preferably at least one selected from the group consisting of a polymerizable functional group, an aryl group, and an alkyl group. A plurality of R¹'s in the present constitutional unit may be the same or different from each other.

R¹ of the present constitutional unit may be a hydrogen atom. In a case where R¹ is a hydrogen atom, for example, in a case where at least one of the present constitutional unit or another constitutional unit includes an organic group having 2 or more and 10 or less carbon atoms, that includes a carbon-carbon unsaturated bond capable of being hydrosilylated and is included in the polymerizable functional group (hereinafter, also simply referred to as an unsaturated organic group), a crosslinking reaction may occur between these units.

R¹ of the present constitutional unit may be an alkyl group. The alkyl group may be an aliphatic group or an alicyclic group, and may be linear or branched. The number of carbon atoms in the alkyl group is, for example, preferably 1 or more and 10 or less, more preferably 1 or more and 4 or less, still more preferably 1 or more and 2 or less, and particularly preferably 1, that is, a methyl group. Specific examples of the alkyl group having 1 or more and 10 or less carbon atoms include a methyl group, an ethyl group, a propyl group, a butyl group, a pentyl group, a hexyl group, a heptyl group, an octyl group, a nonyl group, and a decyl group.

R¹ of the present constitutional unit may be an alkenyl group. The alkenyl group may be an aliphatic group, an alicyclic group, or an aromatic group, and may be linear or branched. The number of carbon atoms in the alkenyl group is, for example, preferably 1 or more and 10 or less. Specific examples of the alkenyl group having 1 or more and 10 or less carbon atoms include an ethenyl (vinyl) group, an ortho-styryl group, a meta-styryl group, a para-styryl group, a 1-propenyl group, a 2-propenyl (allyl) group, a 1-butenyl group, a 1-pentenyl group, a 3-methyl-1-butenyl group, a phenylethenyl group, an allyl (2-propenyl) group, and an octenyl (7-octen-1-yl) group.

R¹ of the present constitutional unit may be an alkynyl group. The alkynyl group may be an aliphatic group, an alicyclic group, or an aromatic group, and may be linear or branched. The number of carbon atoms in the alkynyl group is, for example, preferably 1 or more and 10 or less. Specific examples of the alkynyl group include an ethynyl group, a 1-propynyl group, a 1-butynyl group, a 1-pentynyl group, a 3-methyl-1-butynyl group, and a phenylbutynyl group.

R¹ of the present constitutional unit may be an aryl group. The number of carbon atoms in the aryl group is, for example, preferably 6 or more and 20 or less, more preferably 6 or more and 10 or less, and still more preferably 6, that is, a phenyl group. Examples of the aryl group having 6 or more and 20 or less carbon atoms include a phenyl group, a 1-naphthyl group, and a 2-naphthyl group.

R¹ of the present constitutional unit may be an aralkyl group. The number of carbon atoms in the aralkyl group is, for example, preferably 7 or more and 20 or less, and more preferably 7 or more and 10 or less. Examples of the aralkyl group having 7 or more and 20 or less carbon atoms include a phenylalkyl group such as a benzyl group.

R¹ of the present constitutional unit may be —C(═O)—CR³₃. R³ represents a hydrogen atom, a methyl group, or an ethyl group. R³ is, for example, preferably a methyl group. In a case of a plurality of R³'s, the plurality of R³'s may be the same or different from each other.

R¹ of the present constitutional unit may be a monovalent organic group having a reactive group (polymerizable functional group). Examples of the polymerizable functional group include a polymerizable functional group that can be thermoset or photocured. The polymerizable functional group is not particularly limited, and examples thereof include a vinyl group, an allyl group, a styryl group, a methacryloyl group, an acryloyl group, an acryloyloxy group, a methacryloyloxy group, an α-methylstyryl group, a vinyl ether group, a vinyl ester group, an acrylamide group, a methacrylamide group, an N-vinyl amide group, a maleic acid ester group, a fumaric acid ester group, an N-substituted maleimide group, an isocyanate group, an oxetanyl group, and an epoxy group. Among these, as the polymerizable functional group, for example, a polymerizable functional group having a (meth)acryloyl group, an oxetanyl group, or an epoxy group is preferable. The polymerizable functional group may be further substituted with a halogen atom, a hydroxy group, an alkoxy group, an aryloxy group, an aralkyloxy group, or an oxy group.

As the polymerizable functional group having a (meth)acryloyl group, for example, a group represented by the following formula or a group including the group is preferable.

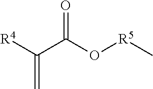

In the formula, R⁴ represents a hydrogen atom or a methyl group, and R⁵ represents an alkylene group having 1 or more and 10 or less carbon atoms. R⁴ is, for example, preferably an alkylene group having 2 or more and 10 or less carbon atoms.

The oxetanyl group is not particularly limited, and examples thereof include a (3-ethyl-3-oxetanyl)methoxy group and a (3-ethyl-3-oxetanyl)oxy group. As the polymerizable functional group having an oxetanyl group, for example, a group represented by the following formula or a group including the group is preferable.

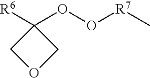

In the formula, R⁶ represents a hydrogen atom or an alkyl group having 1 or more and 6 or less carbon atoms, and R⁷ represents an alkylene group having 1 or more and 6 or less carbon atoms. R⁶ is, for example, preferably a hydrogen atom, a methyl group, an ethyl group, or the like, and more preferably an ethyl group. R⁷ is, for example, preferably an alkylene group having 2 or more and 6 or less carbon atoms, and more preferably a propylene group.

The polymerizable functional group having an epoxy group is not particularly limited, and examples thereof include an alkyl group having 1 or more and 10 or less carbon atoms, that is substituted with a glycidyloxy group, such as β-glycidyloxyethyl, γ-glycidyloxypropyl, and γ-glycidyloxybutyl; and an alkyl group having 5 or more and 10 or less carbon atoms, that is substituted with an oxirane group, such as a glycidyl group, a β-(3,4-epoxycyclohexyl)ethyl group, a γ-(3,4-epoxycyclohexyl)propyl group, a β-(3,4-epoxycycloheptyl)ethyl group, a 4-(3,4-epoxycyclohexyl)butyl group, and a 5-(3,4-epoxycyclohexyl)pentyl group.

The polymerizable functional group may be a functional group having a carbon-carbon double bond or a carbon-carbon triple bond, that can be hydrosilylated with a hydrogen atom (hydrosilyl group) bonded to a silicon atom. The unsaturated organic group can also function as the polymerizable functional group in a sense that the hydrogen atom in the hydrosilyl group polymerizes by a hydrosilylation reaction to form a hydrosilylated structural part. Specific examples of the unsaturated organic group include the above-described alkenyl group, alkynyl group, and the like. The unsaturated organic group is not particularly limited, and examples thereof include a vinyl group, an ortho-styryl group, a meta-styryl group, a para-styryl group, an acryloyl group, a methacryloyl group, an acryloxy group, a methacryloxy group, a 1-propenyl group, a 1-butenyl group, a 1-pentenyl group, a 3-methyl-1-butenyl group, a phenylethenyl group, an ethynyl group, a 1-propynyl group, a 1-butynyl group, a 1-pentynyl group, a 3-methyl-1-butynyl group, a phenylbutynyl group, an allyl(2-propenyl) group, and an octenyl (7-octen-1-yl) group. The unsaturated organic group is, for example, preferably a vinyl group, a para-styryl group, an allyl(2-propenyl) group, or an octenyl (7-octen-1-yl) group, and more preferably a vinyl group.

The siloxane compound represented by Formula 1 may include two or more kinds of the polymerizable functional groups in the entire molecule. In this case, all the polymerizable functional groups may be the same or different from each other. In addition, the plurality of polymerizable functional groups may be the same and may further include different polymerizable functional groups.

The alkyl group, the alkenyl group, the alkynyl group, the aralkyl group, the aryl group, —C(═O)—CR³₃, and the polymerizable functional group, represented by R¹, may have a substituent. Examples of the substituent include at least one or more of a halogen atom such as a fluorine atom, a chlorine atom, a bromine atom, and an iodine atom; an alkyl group such as a methyl group, an ethyl group, a n-propyl group, an isopropyl group, a n-butyl group, a s-butyl group, an isobutyl group, a tert-butyl group, a n-pentyl group, a n-hexyl group, a n-heptyl group, a n-octyl group, and an isooctyl group; a hydroxy group; an alkoxy group; an aryloxy group; an aralkyloxy group; an oxy group (═O); a cyano group; a protected hydroxyl group; and the like.

A protecting group of the hydroxyl group in the protected hydroxyl group is not particularly limited, and a known hydroxyl group-protecting group is used. Examples of the protecting group include an acyl-based protecting group represented by —C(═O)R (in the formula, R represents an alkyl group having 1 or more and 6 or less carbon atoms, such as a methyl group, an ethyl group, a n-propyl group, an isopropyl group, a n-butyl group, an isobutyl group, a s-butyl group, a tert-butyl group, and an n-pentyl group, or a phenyl group having or not having a substituent; examples of the substituent of the phenyl group having a substituent include an alkyl group such as a methyl group, an ethyl group, a n-propyl group, an isopropyl group, a n-butyl group, a s-butyl group, an isobutyl group, a tert-butyl group, a n-pentyl group, a n-hexyl group, a n-heptyl group, a n-octyl group, and an isooctyl group, a halogen atom such as a fluorine atom, a chlorine atom, and a bromine atom, an alkoxy group such as a methoxy group and an ethoxy group, and the like); a silyl-based protecting group such as a trimethylsilyl group, a triethylsilyl group, a tert-butyldimethylsilyl group, and a tert-butyldiphenylsilyl group; an acetal-based protecting group such as a methoxymethyl group, a methoxyethoxymethyl group, a 1-ethoxyethyl group, a tetrahydropyran-2-yl group, and a tetrahydrofuran-2-yl group; an alkoxycarbonyl-based protecting group such as a t-butoxycarbonyl group; and an ether-based protecting group such as a methyl group, an ethyl group, a tert-butyl group, an octyl group, an allyl group, a triphenylmethyl group, a benzyl group, a p-methoxybenzyl group, a fluorenyl group, a trityl group, and a benzhydryl group.

The siloxane compound represented by Formula 1 includes one kind or two or more kinds of the present constitutional units. In the siloxane compound represented by Formula 1, for example, it is preferable that at least a part of the present constitutional units has all of the three R¹'s being alkyl groups, and it is preferable that all of the present constitutional units have all of the three R¹'s being alkyl groups.

a, that is a proportion of the number of moles of the present constitutional unit in the siloxane compound represented by Formula 1, is a positive number of 0 or more and 1 or less. The lower limit value of a is not particularly limited, but is, for example, preferably 0.25 or more, more preferably 0.3 or more, and still more preferably 0.35 or more. The lower limit value of a may be 0.4 or more. The upper limit value of a is not particularly limited, but is, for example, preferably 0.5 or less, and more preferably 0.45 or less.

### Constitutional Unit 2

R¹ of the constitutional unit 2 (that is, the constitutional unit represented by “R¹₂SiO_{2/2}”) is at least one selected from the group consisting of a hydrogen atom, an alkyl group, an alkenyl group, an alkynyl group, an aryl group, an aralkyl group, —C(═O)—CR³₃, and a polymerizable functional group. R¹'s in the present constitutional unit may be the same or different from each other.

The various aspects described for the constitutional unit 1 can also be applied to the alkyl group, the alkenyl group, the alkynyl group, the aryl group, the aralkyl group, —C(═O)—CR³₃, and the polymerizable functional group of the present constitutional unit.

The siloxane compound represented by Formula 1 includes one kind or two or more kinds of the present constitutional units. In the siloxane compound represented by Formula 1, for example, it is preferable that at least a part of the present constitutional units has all of the two R¹'s being alkyl groups, and it is preferable that all of the present constitutional units have all of the two R¹'s being alkyl groups.

b, that is a proportion of the number of moles of the present constitutional unit in the siloxane compound represented by Formula 1, is a positive number of 0 or more and 1 or less. The lower limit value of b is not particularly limited, but is, for example, preferably 0.25 or more, more preferably 0.3 or more, and still more preferably 0.35 or more. The lower limit value of b may be 0.4 or more. The upper limit value of b is not particularly limited, but is, for example, preferably 0.5 or less, and more preferably 0.45 or less.

### Constitutional Unit 3

R¹ in the constitutional unit 3 (that is, the constitutional unit represented by “R¹SiO_{3/2}”) is at least one selected from the group consisting of a hydrogen atom, an alkyl group, an alkenyl group, an alkynyl group, an aralkyl group, an aryl group, —C(═O)—CR³₃, and a monovalent organic group having a reactive group (polymerizable functional group). R¹'s in the present constitutional unit may be the same or different from each other.

The various aspects described for the constitutional unit 1 can also be applied to the alkyl group, the alkenyl group, the alkynyl group, the aralkyl group, the aryl group, —C(═O)—CR³₃, and the polymerizable functional group of the present constitutional unit.

The siloxane compound represented by Formula 1 includes one kind or two or more kinds of the present constitutional units. For example, R¹ of one present constitutional unit may be an alkyl group, and R¹ of the other constitutional unit may be a polymerizable functional group. In addition, for example, R¹ of one present constitutional unit may be a hydrogen atom, and R¹ of the other constitutional unit may be an unsaturated organic group as the polymerizable functional group.

c, that is a proportion of the number of moles of the present constitutional unit in the siloxane compound represented by Formula 1, is a positive number of 0 or more and 1 or less. c is not particularly limited, but is, for example, preferably 0.25 or more and 1 or less, more preferably 0.3 or more and 1 or less, still more preferably 0.35 or more and 1 or less, and particularly preferably 0.4 or more and 1 or less. c may be 0.5 or more, 0.6 or more, 0.7 or more, 0.8 or more, 0.9 or more, 0.95 or more, 0.99 or more, or 1.

### Constitutional Unit 4

The constitutional unit 4 (that is, the constitutional unit represented by “SiO_{4/2}”) has a main chain of polysiloxane. A proportion of the present constitutional unit in the siloxane compound represented by Formula 1 is not particularly limited.

d, that is a proportion of the number of moles of the present constitutional unit in the siloxane compound represented by Formula 1, is a positive number of 0 or more and 1 or less. The lower limit value of d is not particularly limited, but is, for example, preferably 0.25 or more, more preferably 0.3 or more, and still more preferably 0.35 or more. The lower limit value of d may be 0.4 or more. The upper limit value of d is not particularly limited, but is, for example, preferably 0.9 or less.

### Constitutional Unit 5

The constitutional unit 5 (that is, the constitutional unit represented by “R²O_{1/2}”) defines a unit including an alkoxy group or a hydroxyl group in the siloxane compound represented by Formula 1. That is, R² in the present constitutional unit is a hydrogen atom or an alkyl group. The alkyl group may be an aliphatic group or an alicyclic group, and may be linear or branched. The number of carbon atoms in the alkyl group is, for example, preferably 1 or more and 10 or less. Specific examples of the alkyl group having 1 or more and 10 or less carbon atoms include a methyl group, an ethyl group, a n-propyl group, an isopropyl group, a butyl group, a pentyl group, and a hexyl group.

The alkoxy group in the present constitutional unit may be, for example, one that remains in the molecule in a synthesis process of the siloxane compound represented by Formula 1. In addition, the hydroxyl group in the present constitutional unit may be a hydroxyl group or the like, that remains in the molecule without polycondensation after hydrolysis of the “alkoxy group”.

e, that is a proportion of the number of moles of the present constitutional unit in the siloxane compound represented by Formula 1, is a positive number of 0 or more and 1 or less. The lower limit value of e is not particularly limited, but is, for example, preferably 0.2 or more, more preferably 0.25 or more, and still more preferably 0.3 or more. The lower limit value of e may be 0.4 or more. The upper limit value of e is not particularly limited, but is, for example, preferably 0.9 or less.

For example, the siloxane compound represented by Formula 1 preferably includes one or two or more selected from the group consisting of the constitutional unit 1, the constitutional unit 2, and the constitutional unit 4. That is, in Formula 1, for example, it is preferable that one or two or more of a, b, and d are positive numbers of 0 or more.

The siloxane compound represented by Formula 1 may be in a particle shape or a non-particle shape such as a binding resin.

In a case where the siloxane compound represented by Formula 1 is in a particle shape, the particles may be resin particles consisting of only the siloxane compound represented by Formula 1 (hereinafter, also simply referred to as “siloxane resin particles represented by Formula 1”), or may be resin particles formed by mixing the siloxane compound represented by Formula 1 with other resin components.

An average particle diameter of the siloxane resin particles represented by Formula 1 is, for example, preferably 0.01 μm or more and 10.00 μm or less, more preferably 0.10 μm or more and 5.00 μm or less, and still more preferably 0.20 μm or more and 3.00 μm or less.

In a case where the average particle diameter of the siloxane resin particles represented by Formula 1 is 0.01 μm or more, the surface layer has more excellent slipperiness, and thus both occurrence of image shift due to paper slip on the fixing surface and occurrence of paper wrinkles are further suppressed.

In a case where the average particle diameter of the siloxane resin particles represented by Formula 1 is 10.0 μm or less, a surface roughness of the surface layer is suppressed from increasing, and thus the occurrence of paper wrinkles is further suppressed.

A method of measuring the average particle diameter of the siloxane resin particles represented by Formula 1 is as follows.

A sample having a cut surface cut along a thickness direction is obtained from the surface layer of the fixing belt member to be measured. The cut surface of the sample is observed with an electron microscope, an area value of the resin particles is determined by image analysis, and an equivalent circle diameter is calculated from the area value. The equivalent circle diameter is calculated for 100 resin particles. A 50% diameter (D50) in the volume-based cumulative frequency of the obtained equivalent circle diameter is defined as the volume average particle diameter of the siloxane resin particles represented by Formula 1.

A content of the siloxane resin particles represented by Formula 1 with respect to the surface layer is, for example, preferably 1% by mass or more and 20% by mass or less, more preferably 1% by mass or more and 17.5% by mass or less, and still more preferably 1% by mass or more and 15% by mass or less.

In a case where the content of the siloxane resin particles represented by Formula 1 is 1% by mass or more, the surface layer has more excellent slipperiness, and thus both occurrence of image shift due to paper slip on the fixing surface and occurrence of paper wrinkles are further suppressed.

In a case where the content of the siloxane resin particles represented by Formula 1 is 20% by mass or less, a surface roughness of the surface layer is suppressed from increasing, and thus the occurrence of paper wrinkles is further suppressed.

A content of the siloxane compound represented by Formula 1 with respect to the surface layer is, for example, preferably 1.0% by mass or more, more preferably 1.0% by mass or more and 20.0% by mass or less, and still more preferably 1.0% by mass or more and 17.5% by mass or less.

In a case where the content of the siloxane compound represented by Formula 1 is 1.0% by mass or more, the surface layer has more excellent slipperiness, and thus both occurrence of image shift due to paper slip on the fixing surface and occurrence of paper wrinkles are further suppressed.

In a case where the content of the siloxane compound represented by Formula 1 is 20.0% by mass or less, a surface roughness of the surface layer is suppressed from increasing, and thus the occurrence of paper wrinkles is further suppressed.

### Aspect of Surface Layer

The surface layer according to the first exemplary embodiment is a cured product of the composition containing the siloxane compound represented by Formula 1. In addition, as a method for controlling the surface energy and the linear thermal expansion coefficient in the above-described ranges, the surface layer according to the second exemplary embodiment is, for example, preferably a cured product of the composition containing the siloxane compound represented by Formula 1.

The surface layer may be a cured product of a composition containing only the siloxane compound represented by Formula 1 (but, the composition may contain an additive such as a curing agent) without containing other resins, or may be a cured product of a composition in which other resins and the siloxane compound are mixed. In a case where the composition is a mixture of other resins and the siloxane compound, the other resins are, for example, preferably a so-called binding resin.

In a case where the composition is a mixture of other resins and the siloxane compound, the siloxane compound is, for example, preferably a liquid compound or a particle-shaped compound. Examples of the other resins contained in the composition include a polyimide resin (PI resin), a polyamide-imide resin (PAI resin), a polyether ketone resin (for example, an aromatic polyether ether ketone resin or the like), a polyphenylene sulfide resin (PPS resin), a polyetherimide resin (PEI resin), a polyester resin, a polystyrene resin, a polyamide resin, a polycarbonate resin, a silicone resin, and a mixed resin thereof. Among the above, as the other resins, for example, it is preferable to contain a silicone resin. Since the silicone resin has a bonding group similar to a bonding group of the siloxane compound, the silicone resin has excellent affinity with the siloxane compound. Therefore, the siloxane compound is strongly bonded to the silicone resin in the surface layer, and the siloxane compound is less likely to be released from the surface layer, for example, even in a case where friction occurs between the fixing belt member and another member. As a result, interaction between the surface layer and the paper is maintained over a long period, and both the occurrence of image shift due to paper slip on the fixing surface and the occurrence of paper wrinkles are further suppressed.

### Method of Forming Surface Layer

A method of forming the surface layer is not particularly limited, and a conventional method can be applied. Hereinafter, a method of forming the cured product of the composition containing the siloxane compound represented by Formula 1 will be described as the method of forming the surface layer according to the first exemplary embodiment and the surface layer according to the second exemplary embodiment.

In a case where the surface layer is the cured product of the composition containing only the siloxane compound without containing other resins, for example, a cylindrical mold in which the base material of the fixing belt member is installed may be dipped and coated with a solution of the composition containing the siloxane compound represented by Formula 1, and the coating film may be cured (for example, irradiated with ultraviolet rays) to form the surface layer on the base material.

In a case where the surface layer is a cured product of a composition containing liquid other resins and a particle-shaped siloxane compound, for example, the particle-shaped siloxane compound is added to the liquid other resins such as a silicone resin solution, and is stirred to obtain a mixed solution. The cylindrical mold in which the base material of the fixing belt member is installed may be dipped and coated with the mixed solution and cured to form the surface layer on the base material.

### Other Additives

The surface layer may further contain other additives. Examples of the other additives include conductive particles (for example, carbon black), low friction particles (for example, graphite), molybdenum disulfide, and silica particles. A content of each additive can be, for example, 1% by mass or more and 5% by mass or less for the conductive particles, 1% by mass or more and 10% by mass or less for the low friction particles, and 1% by mass or more and 20% by mass or less for the silica particles. In a case where the surface layer contains other additives, the content of the siloxane compound represented by Formula 1 in the composition for forming the surface layer (that is, the cured product) is, for example, preferably 60% by mass or more, and more preferably 80% by mass or more. The content of the siloxane compound represented by Formula 1 in the surface layer may be 100% by mass (that is, may not contain other additives).

### Surface Energy of Surface Layer

The surface layer according to the second exemplary embodiment has a surface energy of 40 mJ/m² or less at 25° C., and for example, preferably has a surface energy of 30 mJ/m² or less.

For example, the surface layer according to the first exemplary embodiment preferably has a surface energy of 40 mJ/m² or less at 25° C., and more preferably has a surface energy of 30 mJ/m² or less.

In any of the first exemplary embodiment and the second exemplary embodiment, the lower limit value of the surface energy of the surface layer at 25° C. is not particularly limited, but may be 1.0 mJ/m² or more, and is, for example, preferably 5.0 mJ/m² or more.

By the surface energy being the upper limit value or less, the release properties of the surface layer with respect to the toner image are increased.

In a case where the surface layer is the cured product of the composition containing the siloxane compound represented by Formula 1, the surface energy is adjusted depending on the kind, content, and the like of the siloxane compound.

The surface energy of the surface layer at 25° C. is measured by the following method.

Using a contact angle meter manufactured by Kyowa Interface Science Co., Ltd., a surface contact angle of the surface layer with respect to three types of reagents (water, diiodomethane, and n-dodecane) is measured. The obtained contact angle values are calculated by an analysis calculation using an extended Fowkes equation (the analysis calculation can be performed by commercially available analysis software) to obtain the surface free energy.

### Linear Thermal Expansion Coefficient of Surface Layer

The surface layer according to the second exemplary embodiment has a linear thermal expansion coefficient of 130 ppm/° C. or less at 150° C., and for example, preferably has a linear thermal expansion coefficient of 120 ppm/° C. or less.

For example, the surface layer according to the first exemplary embodiment preferably has a linear thermal expansion coefficient of 130 ppm/° C. or less at 150° C., and more preferably has a linear thermal expansion coefficient of 120 ppm/° C. or less.

In any of the first exemplary embodiment and the second exemplary embodiment, the lower limit value of the linear thermal expansion coefficient of the surface layer at 150° C. is not particularly limited, but may be 10.0 ppm/° C. or more, and is, for example, preferably 20.0 ppm/° C. or more.

By the linear thermal expansion coefficient being equal to or less than the above-described upper limit value, the difference in thermal expansion coefficient of the fixing belt member between the paper-passing portion and the non-paper-passing portion is less likely to be large. Therefore, the wrinkling deformation at the boundary portion of the fixing belt member is suppressed. As a result, the occurrence of image defects in the fixed image is suppressed.

In a case where the surface layer is the cured product of the composition containing the siloxane compound represented by Formula 1, the linear thermal expansion coefficient is adjusted depending on the kind, content, and the like of the siloxane compound.

The linear thermal expansion coefficient of the surface layer at 150° C. is measured by the following method.

First, a test piece (width: 10 mm, thickness: 4 mm, length: 20 mm) is collected from the surface layer or the fixing belt member. Next, the linear thermal expansion coefficient is calculated from a TMA curve (displacement amount) obtained under a non-vibrational compression load (constant load) while changing a temperature of the test piece from normal temperature (for example, 25° C.) to 180° C. in accordance with JIS K7197 (1991) using a thermomechanical analyzer (TMA).

### Surface Roughness of Surface Layer

A surface roughness Ra of an outer peripheral surface of the surface layer, that is, a surface on a side in contact with the toner image is, for example, preferably 1 μm or less, and more preferably 0.8 μm or less. By the surface roughness Ra being in the above-described range, fixing properties are improved.

The surface roughness Ra is obtained as follows. A measurement sample is cut out from the surface layer (or the fixing belt member having the surface layer). Ra is measured for the measurement sample using a stylus type surface roughness measuring machine (SURFCOM 1400A; manufactured by Tokyo Seimitsu Co., Ltd.). The measurement conditions are in accordance with JIS B 0601-1994, and the evaluation length Ln is set to 2.5 mm, the reference length L is set to 0.8 mm, and the cut-off value is set to 0.008 mm.

### Average Film Thickness of Surface Layer

An average film thickness of the surface layer is, for example, preferably 30 μm or less, and more preferably 1 μm or more and 20 μm or less. From the viewpoint of abrasion resistance, for example, it is preferable that the average film thickness of the surface layer is equal to or less than the above-described upper limit value.

### Base Material and Elastic Layer

The fixing belt member includes at least the surface layer on the base material. Furthermore, the fixing belt member may include an elastic layer between the base material and the surface layer.

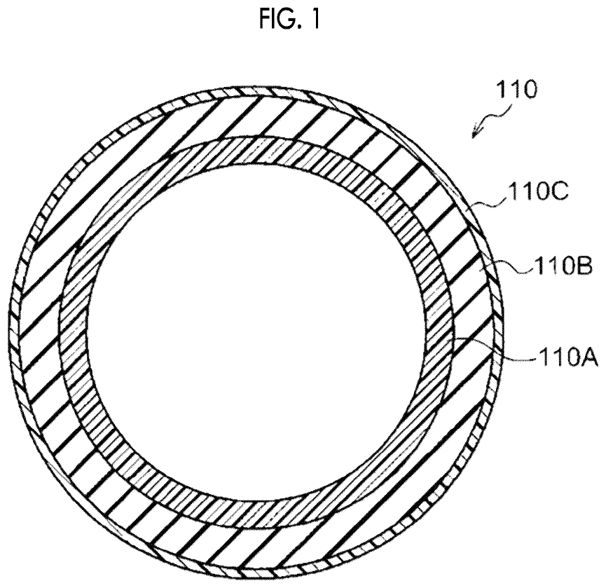

Hereinafter, a configuration of the fixing belt member provided in the fixing device according to the present exemplary embodiment will be described with reference to FIG. 1.

FIG. 1 is a view schematically showing a configuration of an example of the fixing belt member according to the present exemplary embodiment.

A fixing belt member 110 shown in FIG. 1 includes a base material layer 110A, an elastic layer 110B provided on the base material layer 110A, and a surface layer 110C provided on the elastic layer 110B.

A layer configuration of the fixing belt member 110 according to the present exemplary embodiment is not limited to the layer configuration shown in FIG. 1, and the fixing belt member 110 may not include the elastic layer 110B or may not include the base material layer 110A. The fixing belt member 110 according to the present exemplary embodiment may have a layer configuration in which a metal layer and a protective layer for the metal layer are interposed between the base material layer 110A and the elastic layer 110B; a layer configuration in which an adhesive layer is interposed between the base material layer 110A and the elastic layer 110B; a layer configuration in which an adhesive layer is interposed between the elastic layer 110B and the surface layer 110C; or a layer configuration obtained by combining the layer configurations.

Hereinafter, constituent components of the fixing belt member according to the present exemplary embodiment will be described in detail. The reference numerals will not be provided.

### Base Material Layer

Examples of the base material layer include a resin layer containing a resin such as polyimide. In addition, the base material layer may contain an additive such as a filler in the resin.

Examples of the polyimide include an imidized polyamic acid (polyimide precursor) that is a polymer of a tetracarboxylic dianhydride and a diamine compound. Specific examples of the polyimide include a resin obtained by polymerizing equimolar amounts of a tetracarboxylic dianhydride and a diamine compound in a solvent to obtain a polyamic acid solution, and imidizing the polyamic acid.

Examples of the tetracarboxylic dianhydride include an aromatic tetracarboxylic dianhydride compound and an aliphatic tetracarboxylic dianhydride compound; and from the viewpoint of heat resistance, for example, an aromatic tetracarboxylic dianhydride compound is preferable.

Examples of the aromatic tetracarboxylic dianhydride include pyromellitic dianhydride, 3,3′,4,4′-benzophenone tetracarboxylic dianhydride, 3,3′,4,4′-biphenylsulfone tetracarboxylic dianhydride, 1,4,5,8-naphthalenetetracarboxylic dianhydride, 2,3,6,7-naphthalenetetracarboxylic dianhydride, 3,3′,4,4′-biphenyl ether tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furane tetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidene diphthalic dianhydride, 3,3′,4,4′-biphenyltetracarboxylic dianhydride, 2,3,3′,4′-biphenyltetracarboxylic dianhydride, bis(phthalic)phenylphosphine oxide dianhydride, p-phenylene-bis(triphenylphthalic)dianhydride, m-phenylene-bis(triphenylphthalic)dianhydride, bis(triphenylphthalic)-4,4′-diphenyl ether dianhydride, and bis(triphenylphthalic)-4,4′-diphenylmethane dianhydride.

Examples of the aliphatic tetracarboxylic dianhydride include aliphatic or alicyclic tetracarboxylic dianhydrides such as butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic acid dianhydride, 3,5,6-tricarboxynorbornane-2-acetic acid dianhydride, 2,3,4,5-tetrahydrofuran tetracarboxylic dianhydride, 5-(2,5-dioxotetrahydrofuryl)-3-methyl-3-cyclohexene-1,2-dicarboxylic acid dianhydride, and bicyclo[2,2,2]-oct-7-ene-2,3,5,6-tetracarboxylic dianhydride; and aliphatic tetracarboxylic dianhydrides having an aromatic ring, such as 1,3,3a,4,5,9b-hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione.

Among these, as the tetracarboxylic dianhydride, for example, an aromatic tetracarboxylic dianhydride is preferable, and specifically, for example, pyromellitic dianhydride, 3,3′,4,4′-biphenyltetracarboxylic dianhydride, 2,3,3′,4′-biphenyltetracarboxylic dianhydride, 3,3′,4,4′-biphenylethertetracarboxylic dianhydride, or 3,3′,4,4′-benzophenonetetracarboxylic dianhydride is preferable; pyromellitic dianhydride, 3,3′,4,4′-biphenyltetracarboxylic dianhydride, or 3,3′,4,4′-benzophenonetetracarboxylic dianhydride is more preferable; and 3,3′,4,4′-biphenyltetracarboxylic dianhydride is particularly preferable.

The tetracarboxylic dianhydride may be used alone, or two or more kinds thereof may be used in combination.

In a case where two or more tetracarboxylic dianhydrides are used in combination, either aromatic tetracarboxylic dianhydrides or aliphatic tetracarboxylic dianhydrides may be used in combination, or an aromatic tetracarboxylic dianhydride and an aliphatic tetracarboxylic dianhydride may be used in combination.

Meanwhile, the diamine compound is a diamine compound having two amino groups in the molecular structure. Examples of the diamine compound include an aromatic diamine compound and an aliphatic diamine compound, and for example, an aromatic diamine compound is preferable.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindan, 6-amino-1-(4′-aminophenyl)-1,3,3-trimethylindan, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)biphenyl, 1,3′-bis(4-aminophenoxy)benzene, 9,9-bis(4-aminophenyl)fluorene, 4,4′-(p-phenylene isopropylidene)bisaniline, 4,4′-(m-phenylene isopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamines having two amino groups bonded to an aromatic ring and a heteroatom other than a nitrogen atom of the amino groups, such as diaminotetraphenylthiophene; and aliphatic diamines and alicyclic diamines such as 1,1-m-xylylenediamine, 1,3-propane diamine, tetramethylenediamine, pentamethylenediamine, octamethylenediamine, nonamethylenediamine, 4,4-diaminoheptamethylenediamine, 1,4-diaminocyclohexane, isophorone diamine, tetrahydrodicyclopentadienylenediamine, hexahydro-4,7-methanoin danylene dimethylenediamine, tricyclo[6,2,1,0^{2,7}]-undecylene dimethyldiamine, and 4,4′-methylenebis(cyclohexylamine).

Among these, as the diamine compound, for example, an aromatic diamine compound is preferable, and specifically, for example, p-phenylenediamine, m-phenylenediamine, 4,4′-diaminodiphenylmethane, 4,4′-diaminodiphenylether, 3,4′-diaminodiphenylether, 4,4′-diaminodiphenylsulfide, or 4,4′-diaminodiphenylsulfone is preferable, and 4,4′-diaminodiphenylether or p-phenylenediamine is particularly preferable.

The diamine compound may be used alone, or two or more kinds thereof may be used in combination.

In a case where two or more diamine compounds are used in combination, either aromatic diamine compounds or aliphatic diamine compounds may be used in combination, or an aromatic diamine compound and an aliphatic diamine compound may be combined.

Among these, from the viewpoint of heat resistance, as the polyimide, for example, an aromatic polyimide (specifically, an imidized polyamic acid (polyimide precursor) that is a polymer of the aromatic tetracarboxylic dianhydride and the aromatic diamine compound) is preferable.

The aromatic polyimide is, for example, more preferably a polyimide having a structural unit represented by General Formula (PI1).

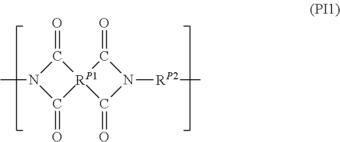

In General Formula (PI1), R^{P1} represents a phenyl group or a biphenyl group, and R^{P2} represents a divalent aromatic group.

Examples of the divalent aromatic group represented by R^{P2} include a phenylene group, a naphthyl group, a biphenyl group, and a diphenyl ether group. As the divalent aromatic group, from the viewpoint of bending durability, for example, a phenylene group or a biphenyl group is preferable.

A number-average molecular weight of the polyimide is, for example, preferably 5,000 or more and 100,000 or less, more preferably 7,000 or more and 50,000 or less, and still more preferably 10,000 or more and 30,000 or less.

The number-average molecular weight of the polyimide is measured by gel permeation chromatography (GPC) under the following measurement conditions.
Column: Tosoh TSK gel α-M (7.8 mm I.D×30 cm)
Eluent: dimethylformamide (DMF)/30 mM LiBr/60 mM phosphoric acid
Flow velocity: 0.6 mL/min
Injection amount: 60 μL
Detector: RI (differential refractive index detector)

Examples of the filler include carbon materials such as acetylene black, graphite, graphitized carbon black, and non-graphitized carbon black; and metal nitrides such as aluminum nitride, silicon nitride, boron nitride, cerium oxide, and magnesium carbonate.

As necessary, the base material layer may further contain other additives in addition to the polyimide and filler described above. Examples of the other additives include a softener (paraffin-based softener and the like), a processing aid (stearic acid and the like), an aging inhibitor (amine-based aging inhibitor and the like), and a vulcanizing agent (sulfur, a metal oxide, a peroxide, and the like).

From the viewpoint of thermal conductivity, mechanical strength, and the like, a film thickness of the base material layer is, for example, preferably 30 μm or more and 200 μm or less, and particularly preferably 50 μm or more and 150 μm or less.

The base material layer is obtained by preparing a coating liquid for forming a base material layer, that contains the polyimide (further containing an additive such as a filler), applying the coating liquid for forming a base material layer onto a cylindrical mold, and drying the coating liquid.

### Elastic Layer

The elastic layer contains an elastic material. The elastic layer may contain known additives in addition to the elastic material.

Examples of the elastic material include a fluororesin, a silicone resin, silicone rubber, fluororubber, and fluorosilicone rubber. Among the above, as the elastic material, from the viewpoint of heat resistance, thermal conductivity, insulating properties, and the like, for example, silicone rubber or fluororubber is preferable, and silicone rubber is more preferable.

Examples of the silicone rubber include RTV silicone rubber, HTV silicone rubber, and liquid silicone rubber; and specific examples thereof include polydimethyl silicone rubber (MQ), methyl vinyl silicone rubber (VMQ), methyl phenyl silicone rubber (PMQ), and fluorosilicone rubber (FVMQ).

As the silicone rubber, for example, silicone rubber that is crosslinked generally by an addition reaction is preferable. In addition, various types of functional groups are known for silicone rubber, and for example, dimethyl silicone rubber having a methyl group, methyl phenyl silicone rubber having a methyl group and a phenyl group, vinyl silicone rubber having a vinyl group (vinyl group-containing silicone rubber), or the like is preferable.

Furthermore, as the silicone rubber, for example, vinyl silicone rubber having a vinyl group is more preferable, and silicone rubber that has an organopolysiloxane structure having a vinyl group and a hydrogen organopolysiloxane structure having a hydrogen atom bonded to a silicon atom (SiH) is still more preferable.

Examples of the fluororubber include vinylidene fluoride-based rubber, tetrafluoroethylene/propylene-based rubber, tetrafluoroethylene/perfluoromethyl vinyl ether rubber, phosphazene-based rubber, and fluoropolyether rubber.

For example, it is preferable that the elastic material contains silicone rubber as a principal component (that is, a content of the silicone rubber is, for example, preferably 50% by mass or more with respect to the total mass of the elastic material).

The content of the silicone rubber is, for example, more preferably 90% by mass or more, and still more preferably 99% by mass or more with respect to the total mass of the elastic material used in the elastic layer, and the content of the silicone rubber may be 100% by mass.

The elastic layer may contain additives such as a filler, a softener (such as a paraffin-based softener), a processing aid (such as stearic acid), an antioxidant (such as an amine-based antioxidant), and a vulcanizing agent (such as sulfur, a metal oxide, or a peroxide).

The elastic layer may be formed by a known method, and for example, a coating method is used.

In a case where the silicone rubber is used as the elastic material of the elastic layer, for example, first, a coating liquid for forming an elastic layer, that contains liquid silicone rubber that turns into silicone rubber by being cured by heating, is prepared. Next, the base material layer is coated with the coating liquid for forming an elastic layer to form a coating film, and the coating film is vulcanized as necessary, thereby forming an elastic layer on the base material layer. During the vulcanization of the coating film, a vulcanization temperature is, for example, 150° C. or higher and 250° C. or lower, and the vulcanization time is, for example, 30 minutes or longer and 120 minutes or shorter.

An average film thickness of the elastic layer is, for example, preferably 300 μm or more. By the film thickness of the elastic layer being equal to or more than the above-described lower limit value, the fixing properties of the toner image are improved.

### Configuration of Fixing Device

The fixing device according to the present exemplary embodiment (that is, the first exemplary embodiment and the second exemplary embodiment) includes the fixing belt member, a heating member that is disposed on an inner surface side of the fixing belt member, and a pressurizing roll member that is disposed to be in contact with an outer surface of the fixing belt member. A toner image is fixed onto a recording medium by bringing the surface layer of the fixing belt member into contact with the toner image on the recording medium, while passing the recording medium between the fixing belt member heated by the heating member and the pressurizing roll member, to perform heating and pressurization.

Hereinafter, an example of a configuration of the fixing device according to the present exemplary embodiment will be described with reference to the drawings.

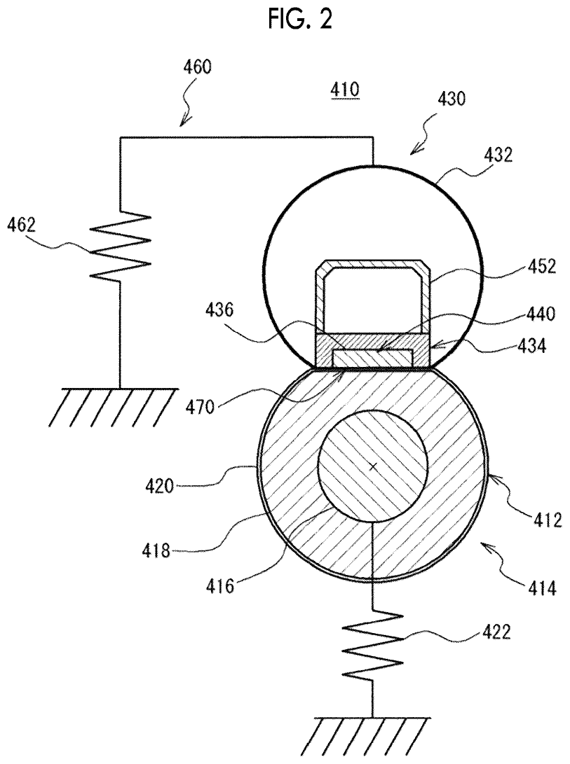

An example of the configuration of the fixing device will be described with reference to FIG. 2. FIG. 2 is a schematic view showing a configuration of an example (that is, a fixing device 410) of the fixing device according to the present exemplary embodiment.

As shown in FIG. 2, the fixing device 410 has a pressure portion 414 and a heating portion 430 facing the pressure portion 414.

The pressure portion 414 includes a cylindrical roll member 412 (an example of the pressurizing roll member), is provided to face the heating portion 430, and is pressed against an outer surface of a heating belt 432 of the heating portion 430 and rotates by a drive device (not shown).

In the pressure portion 414, the roll member 412 is a so-called soft roll having a shaft portion 416 that consists of, for example, a metal material such as iron, stainless steel, and aluminum, an elastic layer 418 that covers the shaft portion 416, and a release layer 420 that coats or is applied to the elastic layer 418. The release layer 420 is formed of an insulating material having excellent release properties, such as PFA.

In the pressure portion 414, the roll member 412 is grounded, and the pressure portion 414 is grounded from the shaft portion 416 of the roll member 412 with a pressurizing portion-side resistor 422 interposed therebetween. By grounding the pressure portion 414 through the pressurizing portion-side resistor 422 in this way, the current leakage (leakage current) from the electrode of a planar heating element 440 (an example of the heating member) of the heating portion 430 is suppressed.

In the pressure portion 414, the roll member 412 is pressed on the heating portion 430 by a pressing member (not shown) made of an elastic substance such as a coil spring. For example, one end of the pressing member is mounted on the shaft portion 416, and the other end is mounted on a body of an image forming apparatus.

The heating portion 430 has the heating belt 432 (an example of the fixing belt member) and has, on the inside of the heating belt 432, the planar heating element 440 that is a heating member heating the heating belt 432 from the inner peripheral surface side, a holding member 434 that holds the planar heating element 440, and a frame member 452 that supports the holding member 434. The holding member 434 is supported by the frame member 452, and has a structure that can withstand the pressure from the pressure portion 414. A lubricant such as a lubricating grease may be applied to the inner surface of the heating belt 432 in contact with the planar heating element 440.

In the heating portion 430, for example, circular support members (not shown) that support the heating belt 432 are provided at both ends of the heating belt 432 in a longitudinal direction. A heating member gear (not shown) that rotates the heating belt 432 is provided on the support member, and one side of the heating member gear is connected to a drive device (not shown) such as a motor in the body of the image forming apparatus. The heating belt 432 may be rotated by pressing the roll member 412 that rotates the heating belt 432, without providing the heating member gear to the heating belt 432.

In the heating portion 430, the planar heating element 440 as the heating member is, for example, in the form of a long plate-shaped element extending in the longitudinal direction of the heating portion 430. The planar heating element 440 has an electrically insulating substrate, an insulating layer formed of a polyimide-based heat-resistant resin, a pair of electrodes for power supply, and a resistive heating portion made, for example, of stainless steel that generates heat by being supplied with power from the electrodes. The electrodes and the resistive heating portion are connected by a power supply portion, and the electrodes, the power supply portion, and the resistive heating portion are embedded in an insulating layer. The electrodes of the planar heating element 440 are grounded with the heating portion-side resistor 462 interposed therebetween.

In the heating portion 430, the holding member 434 is formed of, for example, a resin material such as liquid crystal polymer (LCP) having high heat resistance, and on a side of the heating portion 430 facing the pressure portion 414, a groove portion 436 for holding the planar heating element 440 is formed along the longitudinal direction.

The holding member 434 is configured to form a pressing region 470 in a case where the holding member 434 is pressed on the pressure portion 414 in a state in which the planar heating element 440 is held in the groove portion 436.

In the heating portion 430, the frame member 452 is formed of, for example, a metal material, and the frame member 452 is configured to support the holding member 434, to be fixed to a support member (not shown) through both ends of the frame member 452, and enable the holding member 434 to withstand the pressure from the pressure portion 414. The heating portion 430 may be provided with a thermistor or the like for temperature detection.

In the fixing device 410 described above, the pressing region 470 is formed in a state of sandwiching the heating belt 432 by the roll member 412 of the pressure portion 414 and a unit consisting of the planar heating element 440, the holding member 434, and the frame member 452 of the heating portion 430. The recording medium on which the unfixed toner image is held is caused to pass through the pressing region 470 to fix the unfixed toner image onto the recording medium by applying heat and pressure.

### Image Forming Apparatus

Next, the image forming apparatus according to the present exemplary embodiment will be described.

The image forming apparatus according to the present exemplary embodiment includes an image holder, a charging device that charges a surface of the image holder, a latent image forming device that forms a latent image on the charged surface of the image holder, a developing device that develops the latent image by a toner to form a toner image, a transfer device that transfers the toner image to a recording medium, and a fixing device that fixes the toner image to the recording medium.

As the fixing device, the fixing device according to the present exemplary embodiment is applied.

In the image forming apparatus according to the present exemplary embodiment, the fixing device may be made into a cartridge such that the fixing device is detachable from an image forming apparatus. That is, the image forming apparatus according to the present exemplary embodiment may include the fixing device according to the present exemplary embodiment, as a device configuring a process cartridge.

Hereinafter, the image forming apparatus according to the present exemplary embodiment will be described with reference to a drawing.

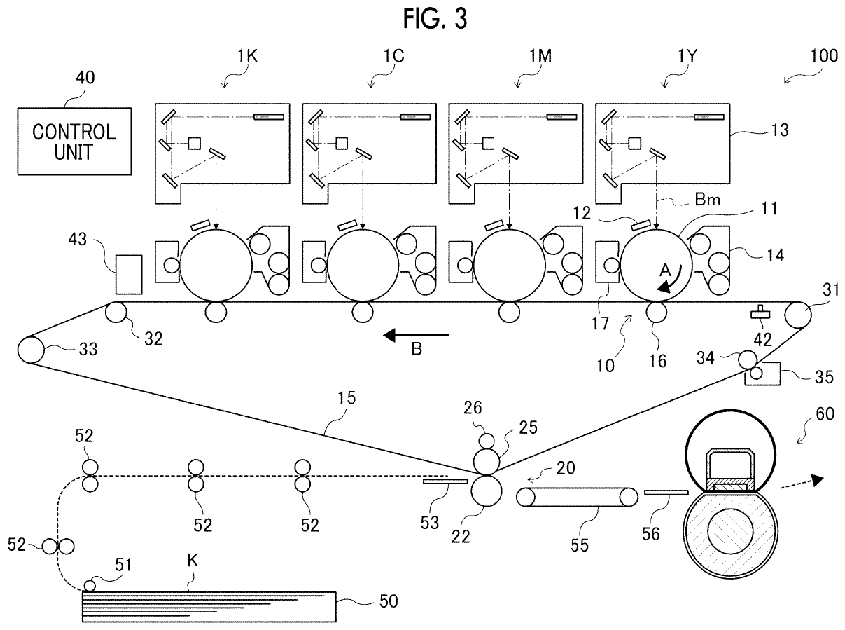

FIG. 3 is a view schematically showing a configuration of an example of the image forming apparatus according to the present exemplary embodiment.

As shown in FIG. 3, an image forming apparatus 100 according to the present exemplary embodiment is, for example, an intermediate transfer-type image forming apparatus that is generally called a tandem type, and includes a plurality of image forming units 1Y, 1M, 1C, and 1K in which a toner image of each color component is formed by an electrophotographic method, a primary transfer unit 10 that performs sequential transfer (primary transfer) of the toner image of each color component formed by each of the image forming units 1Y, 1M, 1C, and 1K to an intermediate transfer belt 15, a secondary transfer unit 20 that performs batch transfer (secondary transfer) of the overlapped toner images transferred to the intermediate transfer belt 15 to paper K as a recording medium, and a fixing device 60 that fixes the images transferred by the secondary transfer on the paper K. In addition, the image forming apparatus 100 includes a control unit 40 that controls the operation of each device (each unit).

The fixing device 60 is the first exemplary embodiment of the fixing device described above. The image forming apparatus 100 may be configured to include the second exemplary embodiment of the fixing device described above.

Each of the image forming units 1Y, 1M, 1C, and 1K of the image forming apparatus 100 includes a photoreceptor 11 that rotates in a direction of an arrow A, as an example of an image holder that holds a toner image formed on the surface.

As an example of the charging unit, a charger 12 for charging the photoreceptor 11 is provided around the photoreceptor 11, and as an example of the latent image forming unit, a laser exposure device 13 that draws an electrostatic latent image on the photoreceptor 11 is provided (in the figure, an exposure beam is represented by a reference numeral Bm).

Around the photoreceptor 11, as an example of a developing unit, there are provided a developer 14 that accommodates toners of each color component and makes the electrostatic latent image on the photoreceptor 11 into a visible image by using the toners and a primary transfer roll 16 that transfers toner images of each color component formed on the photoreceptor 11 to the intermediate transfer belt 15 by the primary transfer unit 10.

Furthermore, around the photoreceptor 11, there are provided a photoreceptor cleaner 17 that removes the residual toner on the photoreceptor 11 and devices for electrophotography, such as the charger 12, the laser exposure device 13, the developer 14, the primary transfer roll 16, and the photoreceptor cleaner 17, that are arranged in sequence along the rotation direction of the photoreceptor 11. These image forming units 1Y, 1M, 1C, and 1K are substantially linearly arranged in order of yellow (Y), magenta (M), cyan (C), and black (K) from the upstream side of the intermediate transfer belt 15.

The intermediate transfer belt 15 that is an intermediate transfer body is configured with a film-shaped pressure belt including a base layer that is a resin such as polyimide and polyamide, and containing an appropriate amount of an antistatic agent such as carbon black. The intermediate transfer belt 15 is configured to have a volume resistivity of 10⁶ Ωcm or more and 10¹⁴ Ωcm or less, and has a thickness of, for example, approximately 0.1 mm.

By various rolls, the intermediate transfer belt 15 is driven to circulate (rotate) in the B direction shown in FIG. 3 at a speed fit for the purpose. The image forming apparatus 100 has, as the various rolls, a drive roll 31 that is driven by a motor (not shown) excellent in maintaining a constant speed and rotates the intermediate transfer belt 15, a support roll 32 that supports the intermediate transfer belt 15 substantially linearly extending along the arrangement direction of each photoreceptor 11, a tension applying roll 33 that applies tension to the intermediate transfer belt 15 and functions as a correcting roll preventing meandering of the intermediate transfer belt 15, a back roll 25 that is provided in the secondary transfer unit 20, and a cleaning back roll 34 that is provided in a cleaning portion scrapping off the residual toner on the intermediate transfer belt 15.

The primary transfer unit 10 is configured with the primary transfer roll 16 that is disposed to face the photoreceptor 11 across the intermediate transfer belt 15. The primary transfer roll 16 is configured with a core and a sponge layer as an elastic layer, fixed around the core. The core is a cylindrical rod constituted of a metal such as iron and SUS. The sponge layer is a sponge-like cylindrical roll that is formed of blended rubber of NBR, SBR, and EPDM mixed with a conductive material such as carbon black, and has a volume resistivity of 10^{7.5} Ωcm or more and 10^{8.5} Ωcm or less.

The primary transfer roll 16 is disposed to be pressed against the photoreceptor 11 with the intermediate transfer belt 15 therebetween, and a voltage with a polarity (primary transfer bias) opposite to the charging polarity (negative polarity; the same applies hereafter) of the toner is applied to the primary transfer roll 16. As a result, the toner image on each photoreceptor 11 is sequentially electrostatically sucked onto the intermediate transfer belt 15, which leads to the formation of overlapped toner images on the intermediate transfer belt 15.

The secondary transfer unit 20 is configured to include the back roll 25 and a secondary transfer roll 22 that is disposed on a toner image-holding surface side of the intermediate transfer belt 15.

A surface of the back roll 25 is configured with a tube of blended rubber of EPDM and NBR in which carbon is dispersed, and the inside of the back roll 25 is configured with EPDM rubber. The back roll 25 is formed such that a surface resistivity thereof is 10⁷Ω/□ or more and 10¹⁰Ω/□ or less, and a hardness of the back roll 25 is set to, for example, 70° (ASKER C: manufactured by KOBUNSHI KEIKI CO., LTD.; the same applies hereinafter). The back roll 25 is disposed on the back surface side of the intermediate transfer belt 15 to configure a counter electrode of the secondary transfer roll 22, and a power supply roll 26 made of a metal to which secondary transfer bias is stably applied is disposed to come into contact with the back roll 25.

The secondary transfer roll 22 is configured with a core and a sponge layer as an elastic layer, fixed around the core. The core is a cylindrical rod constituted of a metal such as iron and SUS. The sponge layer is a sponge-like cylindrical roll that is formed of blended rubber of NBR, SBR, and EPDM mixed with a conductive material such as carbon black, and has a volume resistivity of 10^{7.5} Ωcm or more and 10^{8.5} Ωcm or less.

The secondary transfer roll 22 is disposed to be pressed on the back roll 25 across the intermediate transfer belt 15, and the secondary transfer roll 22 is grounded such that the secondary transfer bias is formed between the secondary transfer roll 22 and the back roll 25, that induces secondary transfer of the toner image onto the paper K transported to the secondary transfer unit 20.

On the downstream side of the secondary transfer unit 20 of the intermediate transfer belt 15, an intermediate transfer belt cleaner 35 that removes the residual toner or paper powder on the intermediate transfer belt 15 remaining after the secondary transfer and cleans the surface of the intermediate transfer belt 15 is provided to be separable from the intermediate transfer belt 15.

The intermediate transfer belt 15, the primary transfer unit 10 (primary transfer roll 16), and the secondary transfer unit 20 (secondary transfer roll 22) correspond to an example of the transfer unit.

On the other hand, on the upstream side of the yellow image forming unit 1Y, a reference sensor (home position sensor) 42 is disposed that generates a reference signal to be a reference for taking the image forming timing in each of the image forming units 1Y, 1M, 1C, and 1K. The reference sensor 42 recognizes a mark provided on the back side of the intermediate transfer belt 15 and generates a reference signal, and each of the image forming units 1Y, 1M, 1C, and 1K is configured such that these units start to form images according to the instruction from the control unit 40 based on the recognition of the reference signal.

In addition, an image density sensor 43 used to adjust image quality is provided on the downstream side of the black image forming unit 1K.

The image forming apparatus according to the present exemplary embodiment includes, as a transport unit for transporting the paper K, a paper storage portion 50 that stores the paper K, a paper feeding roll 51 that takes out and transports the paper K stacked in the paper storage portion 50 at a predetermined timing, a transport roll 52 that transports the paper K transported by the paper feeding roll 51, a transport guide 53 that sends the paper K transported by the transport roll 52 to the secondary transfer unit 20, a transport belt 55 that transports the paper K transported after going through secondary transfer by the secondary transfer roll 22 to the fixing device 60, and a fixing inlet guide 56 that guides the paper K to the fixing device 60.

Next, basic image forming process of the image forming apparatus according to the present exemplary embodiment will be described.

In the image forming apparatus according to the present exemplary embodiment, image data output from an image reading device (not shown), a personal computer (PC) (not shown), or the like is subjected to image processing by an image processing device (not shown), and then the image forming units 1Y, 1M, 1C, and 1K perform the image forming operation.

In the image processing device, various types of image processing, such as shading correction, misregistration correction, brightness/color space conversion, gamma correction, frame removal or color editing, and movement editing, are performed on input image data. Image data on which the image processing is performed are converted into color material gradation data of four colors, that is, Y, M, C, and K, and are output to the laser exposure device 13.

In the laser exposure device 13, according to the input color material gradation data, for example, the photoreceptor 11 of each of the image forming units 1Y, 1M, 1C, and 1K is irradiated with an exposure beam Bm emitted from a semiconductor laser. The surface of each of the photoreceptors 11 of the image forming units 1Y, 1M, 1C, and 1K is charged by the charger 12, and is then scanned and exposed by the laser exposure device 13, so that the electrostatic latent image is formed. By each of the image forming units 1Y, 1M, 1C, and 1K, the formed electrostatic latent image is developed as a toner image of each of the colors Y, M, C, and K.

The toner image formed on each of the photoreceptors 11 of the image forming units 1Y, 1M, 1C, and 1K is transferred onto the intermediate transfer belt 15 at the primary transfer unit 10 where each photoreceptor 11 and the intermediate transfer belt 15 are in contact with each other. More specifically, in the primary transfer unit 10, by the primary transfer roll 16, a voltage (primary transfer bias) with a polarity opposite to the charging polarity (negative polarity) of the toner is applied to the base material of the intermediate transfer belt 15, and the toner images are sequentially overlapped on the surface of the intermediate transfer belt 15 and subjected to primary transfer.

After the primary transfer by which the toner images are sequentially transferred to the surface of the intermediate transfer belt 15, the intermediate transfer belt 15 moves, and the toner images are transported to the secondary transfer unit 20. In a case where the toner images are transported to the secondary transfer unit 20, in the transport unit, the paper feeding roll 51 rotates in accordance with the timing at which the toner images are transported to the secondary transfer unit 20, and the paper K having the target size is fed from the paper storage portion 50. The paper K fed from the paper feeding roll 51 is transported by the transport roll 52, passes through the transport guide 53, and reaches the secondary transfer unit 20. Before reaching the secondary transfer unit 20, the paper K is temporarily stopped, and a positioning roll (not shown) rotates according to the movement timing of the intermediate transfer belt 15 holding the toner image, so that the position of the paper K is aligned with the position of the toner image.

In the secondary transfer unit 20, through the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer unit 20 pressed by the secondary transfer roll 22 and the back roll 25, the unfixed toner images held on the intermediate transfer belt 15 are electrostatically transferred onto the paper K in a batch.

Thereafter, the paper K to which the toner images are electrostatically transferred is transported in a state of being peeled off from the intermediate transfer belt 15 by the secondary transfer roll 22, and is transported to the transport belt 55 provided on the downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. The paper K on which the fixed image is formed is transported to an ejected paper-storing portion (not shown) provided in an output portion of the image forming apparatus.

Meanwhile, after the transfer to the paper K is finished, the residual toner remaining on the intermediate transfer belt 15 is transported to the cleaning portion as the intermediate transfer belt 15 rotates, and is removed from the intermediate transfer belt 15 by the cleaning back roll 34 and the intermediate transfer belt cleaner 35.

### Control of Image Forming Apparatus

In the image forming apparatus according to the present exemplary embodiment, from the viewpoint of improving the fixing properties of the toner image, for example, it is preferable to sufficiently heat the fixing belt member by the heating member and then fix the toner image onto the recording medium. Therefore, for example, it is preferable to control the driving of the fixing device after receiving a print signal by the following method.

The fixing of the toner image with the heating and pressurization while passing the recording medium between the fixing belt member and the pressurizing roll member is performed in a state in which, after a print signal is received, the pressurizing roll member is moved to a position in contact with the outer surface of the fixing belt member, the heating member is heated to a predetermined temperature after the movement of the pressurizing roll member, the fixing belt member and the pressurizing roll member are driven at a speed lower than a speed during the fixing of the image after the temperature of the heating member reaches the predetermined temperature, and a print permission notification is performed after a predetermined time has elapsed from the start of the driving.

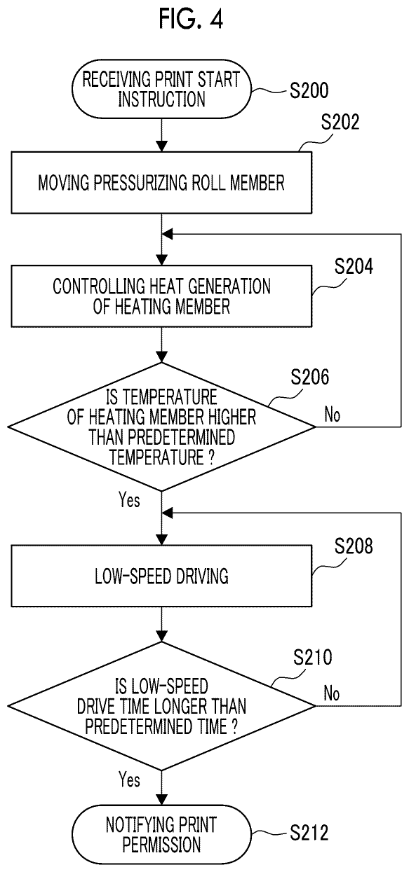

The above-described control method will be specifically described. FIG. 4 is a flowchart showing an example of a flow of the driving of the fixing device in the image forming apparatus according to the present exemplary embodiment, in a case where a print start instruction is received.

In a step S200, the control unit in the image forming apparatus receives the print signal, that is, the print start instruction. The driving control of the fixing device is started in response to the reception of the print start instruction.

In a step S202, the pressurizing roll member (the roll member 412 in FIG. 2) is moved to a position in contact with the outer surface (that is, a surface on the outer side of the surface layer) of the fixing belt member (the heating belt 432 in FIG. 2).

In a step S204, the heating member (the planar heating element 440 in FIG. 2) is heated. In this case, for example, it is preferable to sufficiently heat the heating member. Specifically, for example, it is preferable to heat the heating member until a temperature of a surface of the heating member in contact with the fixing belt member reaches a predetermined temperature (for example, 100° C.).

In a step S206, it is determined whether or not the temperature of the surface of the heating member in contact with the fixing belt member reaches the predetermined temperature.

In a case where the determination is negative, the process returns to the step S204 to continue the heating of the heating member; and in a case where the determination is positive, the process proceeds to a step S208.

In the step S208, the fixing belt member and the pressurizing roll member are driven at a speed lower than a speed during fixing of an image. By driving at a speed lower than the speed during the fixing of the image, the fixing belt member is sufficiently heated by the heating member. The driving at a speed lower than the speed during the fixing of the image means driving the fixing belt member and the pressurizing roll member at a speed slower than a driving speed in a case of fixing the toner image by causing the recording medium to pass between the fixing belt member and the pressurizing roll member. Specifically, for example, it is preferable to drive the fixing belt member and the pressurizing roll member at a speed of ½ or less with respect to the driving speed in a case of fixing the toner image, and it is more preferable to drive the fixing belt member and the pressurizing roll member at a speed of ⅓ or less.

In a step S210, it is determined whether or not a predetermined time (for example, 3 seconds) has elapsed after the driving of the fixing belt member and the pressurizing roll member at a low speed is started. In a case where the determination is negative, the process returns to the step S208 to continue the driving at a low speed; and in a case where the determination is positive, the process proceeds to a step S212.

In the step S212, the control unit is notified of print permission. By going through the steps S200 to S212, the fixing belt member is sufficiently heated, and thus the fixing properties of the toner image are improved. In a case where the print permission notification is performed, the toner image is formed on the recording medium in the image forming apparatus, and the recording medium having the toner image is caused to pass between the fixing belt member and the pressurizing roll member to perform heating and pressurization. As a result, the toner image is fixed onto the recording medium.

Although the present exemplary embodiment has been described, the present exemplary embodiment is not limited to the above-described exemplary embodiments, and various modifications, changes, and ameliorations may be added thereto.

### EXAMPLES

Hereinafter, the present exemplary embodiment will be described in more detail by Examples, but the present exemplary embodiment is not limited to Examples. In the following description, unless otherwise specified, “part” and “%” are based on mass.

### Production of Fixing Belt Member

### Example 1

A caged-type silsesquioxane compound (SQ1, manufactured by TOAGOSEI CO., LTD., “TM-100”) having a methacryloyl group, that is the siloxane compound represented by Formula 1 described above, is prepared, and the compound is used as a coating material 1 for a surface layer.

As an elastic layer, X34-3160-A/B manufactured by Shin-Etsu Chemical Co., Ltd. is formed on a base material made of φ168 polyimide so that an average film thickness is 500 μm. Next, the above-described coating material 1 for a surface layer is applied as the surface layer, and the coating liquid is cured by ultraviolet irradiation to form the surface layer on the elastic layer so that an average film thickness is 25 μm. In this way, a fixing belt member of Example 1 is obtained.

### Examples 2 and 3

A fixing belt member is obtained in the same manner as in Example 1, except that SQ1 (manufactured by TOAGOSEI CO., LTD., “TM-100”) used for the surface layer of the fixing belt member in Example 1 is changed to a compound shown below.
Example 2: Caged-type silsesquioxane compound (SQ2, manufactured by TOAGOSEI CO., LTD., “SI-20”) having an oxetanyl group, that is the siloxane compound represented by Formula 1 described above
Example 3: Caged-type silsesquioxane compound (SQ3, manufactured by TOAGOSEI CO., LTD., “TX-100”) having an oxetanyl group, that is the siloxane compound represented by Formula 1 described above

### Example 4

A silsesquioxane compound (PSS-Octakis(dimethylsilyloxy) substituted, SQ4, manufactured by NIKKO RICA Co., Ltd., product name “MSP-SN08”, particle shape) in which R¹ in the constitutional unit 3 of [R¹SiO_{3/2}]_{c} of the siloxane compound represented by Formula 1 described above is a dimethylsilyloxy group, and a silicone resin solution (manufactured by Shin-Etsu Chemical Co., Ltd., KS700) are mixed such that a mass ratio of SQ4 to the silicone resin is 15.0% by mass to obtain a coating material 4 for a surface layer.

A fixing belt member is obtained in the same manner as in Example 1, except that the coating material 1 for a surface layer, used for the surface layer of the fixing belt member in Example 1, is changed to the coating material 4 for a surface layer.

### Example 5

A polycarbonate resin (PC, product name TS-2040, manufactured by Teijin Limited) is mixed with tetrahydrofuran (THF, manufactured by FUJIFILM Wako Pure Chemical Corporation) as a solvent such that a resin solid content is 15% by mass, and the mixture is stirred to prepare a resin solution. Particles of a siloxane compound SQ5 shown below are dispersed in the resin solution with a dispersion device of a sand grinding mill such that a mass ratio of SQ5 to the polycarbonate resin is 20.0% by mass to obtain a coating material 5 for a surface layer.

A fixing belt member is obtained in the same manner as in Example 1, except that the coating material 1 for a surface layer, used for the surface layer of the fixing belt member in Example 1, is changed to the coating material 5 for a surface layer.
SQ5: Polymethylsilsesquioxane (trade name MSP-N030, manufactured by Nikko Rica Corporation, particle diameter: 0.3 μm)

### Example 6

A fixing belt member is obtained in the same manner as in Example 4, except that SQ4 (manufactured by NIKKO RICA Co., Ltd., “MSP-SN08”) used for the surface layer of the fixing belt member in Example 4 is changed to the compound SQ5 shown below, and the mass ratio of SQ5 to the silicone resin is changed to 1.0% by mass.
SQ5: Polymethylsilsesquioxane (trade name MSP-N030, manufactured by Nikko Rica Corporation, particle diameter: 0.3 μm)

### Comparative Example 1

A fixing belt member is obtained in the same manner as in Example 1, except that the surface layer of the fixing belt member in Example 1 is changed to a cured layer of a PFA resin (manufactured by DuPont de Nemours, Inc., “451HP”).

### Comparative Example 2

A polycarbonate resin (PC, manufactured by Mitsubishi Gas Chemical Trading, Inc., product name “Iupizeta”) and silicone particles (product name KMP-605, manufactured by Shin-Etsu Chemical Co., Ltd., particle diameter: 2.0 μm) having no siloxane bond group are mixed such that a mass ratio of the silicone particles is 7% by mass to obtain a coating material B2 for a surface layer.

A fixing belt member is obtained in the same manner as in Example 1, except that the surface layer of the fixing belt member in Example 1 is changed to a cured layer of the coating material B2 for a surface layer.

### Measurement of Physical Properties

The surface layer of the fixing belt member obtained in each of Examples is measured for “Surface energy at 25° C.” and “Linear thermal expansion coefficient at 150° C.”. The results are shown in Table 1.

### Evaluation Test

As the image forming apparatus including the fixing device that fixes the toner image by causing the recording medium to pass between the fixing belt member heated by the heating member and the pressurizing roll member and bringing the fixing belt member into contact with the toner image on the recording medium to perform heating and pressurization, a modified machine of APEOS PORT PrintC5570 (manufactured by FUJIFILM Business Innovation Corporation) is prepared. The fixing belt member obtained in each of Examples is mounted in the fixing device of the modified machine. An image is output onto A4 paper in a short edge feed (SEF) direction, and an image is output in black onto A3 paper for each 100 kPV. The evaluation is performed up to 1,500 kPV, and the image quality and the deformation state of the surface of the fixing belt member are confirmed. The results are shown in Table 1.

TABLE 1

| | Surface layer | | | | |
|---|---|---|---|---|---|
| | | | Linear | | |
| | | Surface | thermal | | |
| | | free | expansion | | |
| | | energy | coefficient | (Image quality) | Surface defects of fixing |
| | Material | (mJ/m²) | (ppm/° C.) | Image defects | belt member |
| Example 1 | TM-100 | 22 | 60 | Not up to 1500 kPV | Not up to 1500 kPV |
| Example 2 | SI-20 | 23 | 90 | Not up to 1500 kPV | Not up to 1500 kPV |
| Example 3 | TX-100 | 24 | 120 | Not up to 1500 kPV | Not up to 1500 kPV |
| Example 4 | Particle-shaped | 28 | 118 | Not up to 1500 kPV | Not up to 1500 kPV |
| | silsesquioxane | | | | |
| | compound + | | | | |
| | silicone resin | | | | |
| Example 5 | Particle-shaped | 39 | 121 | Not up to 1400 kPV | Not up to 1500 kPV |
| | silsesquioxane | | | | |
| | compound + | | | | |
| | polycarbonate | | | | |
| | resin | | | | |
| Example 6 | Particle-shaped | 32 | 129 | Not up to 1400 kPV | Not up to 1310 kPV |
| | silsesquioxane | | | | |
| | compound + | | | | |
| | silicone resin | | | | |
| Comparative | PFA | 25 | 180 | At 200 kPV, image defects | At 200 kPV, wrinkle-like |
| Example 1 | | | | occur in A4SEF edge | deformation is observed on |
| | | | | corresponding area of A3 | surface |
| | | | | solid image | |
| Comparative | Polycarbonate | 64 | 150 | At 100 kPV, image defects | At 100 kPV, wrinkle-like |
| Example 2 | resin + silicone | | | occur in A4SEF edge | deformation is observed on |
| | resin | | | corresponding area of A3 | surface |
| | | | | solid image | |

From the results shown in Table 1, it is found that, in Examples, the release properties of the fixing belt member with respect to the toner image are maintained as compared with Comparative Examples, and the occurrence of image defects caused by the wrinkling deformation of the fixing belt member is suppressed.

Hereinafter, aspects of the present invention will be additionally described.

<<<1>>>

A fixing device comprising:
a fixing belt member including a base material and a surface layer that is disposed on the base material and is a cured product of a composition containing a siloxane compound represented by Formula 1;
a heating member that is disposed on an inner surface side of the fixing belt member; and
a pressurizing roll member that is disposed to be in contact with an outer surface of the fixing belt member,

$${( {{R}_{3}^{1} SiO}_{1 / 2} )}_{a} {( {R}_{2}^{1} {SiO}_{2 / 2} )}_{b} {( {R}^{1} {SiO}_{3 / 2} )}_{c} {( {SiO}_{4 / 2} )}_{d} {( {R}^{2} {O}_{1 / 2} )}_{e} , \qquad Formula 1$$

(in Formula 1,
R¹'s each independently represent a hydrogen atom, an alkyl group, an alkenyl group, an alkynyl group, an aralkyl group, an aryl group, a group represented by —C(═O)—CR³₃, or a monovalent organic group having a reactive group, provided that a plurality of R¹'s may be the same or different from each other,
R² represents a hydrogen atom or an alkyl group, provided that a plurality of R²'s may be the same or different from each other,
R³ represents a hydrogen atom, a methyl group, or an ethyl group, provided that a plurality of R³'s may be the same or different from each other,
the monovalent organic group may be substituted with a halogen atom, a hydroxy group, an alkoxy group, an aryloxy group, an aralkyloxy group, or an oxy group, and the alkyl group, the alkenyl group, the alkynyl group, the aralkyl group, and the aryl group may have a substituent, and
a, b, d, and e each independently represent 0 or more and 1 or less, c represents more than 0 and 1 or less, and a+b+c+d+e=1).
   <<<2>>>

A fixing device comprising:
a fixing belt member including a base material and a surface layer that is disposed on the base material, has a surface energy of 40 mJ/m² or less at 25° C., and has a linear thermal expansion coefficient of 130 ppm/° C. or less at 150° C.;
a heating member that is disposed on an inner surface side of the fixing belt member; and
a pressurizing roll member that is disposed to be in contact with an outer surface of the fixing belt member.
   <<<3>>>

The fixing device according to <<<1>>>,
wherein the surface layer of the fixing belt member has a surface energy of 40 mJ/m² or less at 25° C.
   <<<4>>>

The fixing device according to <<<2>>> or <<<3>>>,
wherein the surface layer of the fixing belt member has a surface energy of 30 mJ/m² or less at 25° C.
   <<<5>>>

The fixing device according to <<<1>>> or <<<3>>>,
wherein the surface layer of the fixing belt member has a linear thermal expansion coefficient of 130 ppm/° C. or less at 150° C.
   <<<6>>>

The fixing device according to <<<2>>> or <<<5>>>,
wherein the surface layer of the fixing belt member has a linear thermal expansion coefficient of 120 ppm/° C. or less at 150° C.
   <<<7>>>

The fixing device according to <<<1>>>, <<<3>>>, or <<<5>>>,
wherein at least one of R¹'s is a methyl group or a phenyl group.
   <<<8>>>

The fixing device according to <<<7>>>,
wherein at least one of R¹'s is a methyl group.
   <<<9>>>

An image forming apparatus comprising:
an image holder;
a charging unit that charges a surface of the image holder;
an electrostatic charge image forming unit that forms an electrostatic charge image on the charged surface of the image holder;
a developing unit that accommodates an electrostatic charge image developer containing a toner and develops the electrostatic charge image formed on the surface of the image holder into a toner image;
a transfer unit that transfers the toner image onto a recording medium; and
the fixing device according to any one of <<<1>>> to <<<8>>>, that is configured to fix the toner image onto the recording medium by bringing the surface layer into contact with the toner image on the recording medium, while passing the recording medium between the fixing belt member heated by the heating member and the pressurizing roll member, to perform heating and pressurization.
   <<<10>>>

The image forming apparatus according to <<<9>>>,
wherein the fixing of the toner image with the heating and pressurization while passing the recording medium between the fixing belt member and the pressurizing roll member is performed in a state in which, after a print signal is received, the pressurizing roll member is moved to a position in contact with the outer surface of the fixing belt member, the heating member is heated to a predetermined temperature after the movement of the pressurizing roll member, the fixing belt member and the pressurizing roll member are driven at a speed lower than a speed during the fixing of the image after the temperature of the heating member reaches the predetermined temperature, and a print permission notification is performed after a predetermined time has elapsed from the start of the driving.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a fixing belt member including a base material and a surface layer that is disposed on the base material and is a cured product of a composition containing a siloxane compound represented by Formula 1;
a heating member that is disposed on an inner surface side of the fixing belt member; and
a pressurizing roll member that is disposed to be in contact with an outer surface of the fixing belt member,
$${( {{R}_{3}^{1} SiO}_{1 / 2} )}_{a} {( {R}_{2}^{1} {SiO}_{2 / 2} )}_{b} {( {R}^{1} {SiO}_{3 / 2} )}_{c} {( {SiO}_{4 / 2} )}_{d} {( {R}^{2} {O}_{1 / 2} )}_{e} , \qquad Formula 1$$
(in Formula 1,
R¹'s each independently represent a hydrogen atom, an alkyl group, an alkenyl group, an alkynyl group, an aralkyl group, an aryl group, a group represented by —C(═O)—CR³₃, or a monovalent organic group having a reactive group, provided that a plurality of R¹'s may be the same or different from each other,
R² represents a hydrogen atom or an alkyl group, provided that a plurality of R²'s may be the same or different from each other,
R³ represents a hydrogen atom, a methyl group, or an ethyl group, provided that a plurality of R³'s may be the same or different from each other,
the monovalent organic group may be substituted with a halogen atom, a hydroxy group, an alkoxy group, an aryloxy group, an aralkyloxy group, or an oxy group, and the alkyl group, the alkenyl group, the alkynyl group, the aralkyl group, and the aryl group may have a substituent, and
a, b, d, and e each independently represent 0 or more and 1 or less, c represents more than 0 and 1 or less, and a+b+c+d+e=1).

2. A fixing device comprising:
a fixing belt member including a base material and a surface layer that is disposed on the base material, has a surface energy of 40 mJ/m² or less at 25° C., and has a linear thermal expansion coefficient of 130 ppm/° C. or less at 150° C.;
a heating member that is disposed on an inner surface side of the fixing belt member; and
a pressurizing roll member that is disposed to be in contact with an outer surface of the fixing belt member.

3. The fixing device according to claim 1,
wherein the surface layer of the fixing belt member has a surface energy of 40 mJ/m² or less at 25° C.

4. The fixing device according to claim 2,
wherein the surface layer of the fixing belt member has a surface energy of 30 mJ/m² or less at 25° C.

5. The fixing device according to claim 3,
wherein the surface layer of the fixing belt member has a surface energy of 30 mJ/m² or less at 25° C.

6. The fixing device according to claim 1,
wherein the surface layer of the fixing belt member has a linear thermal expansion coefficient of 130 ppm/° C. or less at 150° C.

7. The fixing device according to claim 2,
wherein the surface layer of the fixing belt member has a linear thermal expansion coefficient of 120 ppm/° C. or less at 150° C.

8. The fixing device according to claim 6,
wherein the surface layer of the fixing belt member has a linear thermal expansion coefficient of 120 ppm/° C. or less at 150° C.

9. The fixing device according to claim 1,
wherein at least one of R¹'s is a methyl group or a phenyl group.

10. The fixing device according to claim 9,
wherein at least one of R¹'s is a methyl group.

11. An image forming apparatus comprising:
an image holder;
a charging unit that charges a surface of the image holder;
an electrostatic charge image forming unit that forms an electrostatic charge image on the charged surface of the image holder;
a developing unit that accommodates an electrostatic charge image developer containing a toner and develops the electrostatic charge image formed on the surface of the image holder into a toner image;
a transfer unit that transfers the toner image onto a recording medium; and
the fixing device according to claim 1, that is configured to fix the toner image onto the recording medium by bringing the surface layer into contact with the toner image on the recording medium, while passing the recording medium between the fixing belt member heated by the heating member and the pressurizing roll member, to perform heating and pressurization.

12. An image forming apparatus comprising:
an image holder;
a charging unit that charges a surface of the image holder;
an electrostatic charge image forming unit that forms an electrostatic charge image on the charged surface of the image holder;
a developing unit that accommodates an electrostatic charge image developer containing a toner and develops the electrostatic charge image formed on the surface of the image holder into a toner image;
a transfer unit that transfers the toner image onto a recording medium; and
the fixing device according to claim 2, that is configured to fix the toner image onto the recording medium by bringing the surface layer into contact with the toner image on the recording medium, while passing the recording medium between the fixing belt member heated by the heating member and the pressurizing roll member, to perform heating and pressurization.

13. The image forming apparatus according to claim 11,
wherein the fixing of the toner image with the heating and pressurization while passing the recording medium between the fixing belt member and the pressurizing roll member is performed in a state in which, after a print signal is received, the pressurizing roll member is moved to a position in contact with the outer surface of the fixing belt member, the heating member is heated to a predetermined temperature after the movement of the pressurizing roll member, the fixing belt member and the pressurizing roll member are driven at a speed lower than a speed during the fixing of the image after the temperature of the heating member reaches the predetermined temperature, and a print permission notification is performed after a predetermined time has elapsed from the start of the driving.

14. The image forming apparatus according to claim 12,
wherein the fixing of the toner image with the heating and pressurization while passing the recording medium between the fixing belt member and the pressurizing roll member is performed in a state in which, after a print signal is received, the pressurizing roll member is moved to a position in contact with the outer surface of the fixing belt member, the heating member is heated to a predetermined temperature after the movement of the pressurizing roll member, the fixing belt member and the pressurizing roll member are driven at a speed lower than a speed during the fixing of the image after the temperature of the heating member reaches the predetermined temperature, and a print permission notification is performed after a predetermined time has elapsed from the start of the driving.
